(19) United States
(12) Patent Application Publication
(10) Pub. No.: US 2004/0100457 A1
(43) Pub. Date: May 27, 2004

(54) Method and system for switching power and loading and closing applications in a portable computing device using a removable pointing device

(76) Inventor: Thomas C. Mandle, Los Altos Hills, CA (US)

Correspondence Address: HEWLETT-PACKARD COMPANY, Intellectual Property Administration, P.O. Box 272400, Fort Collins, CO, 80527-2400, US

(21) Appl. No.: 10/302,434

(22) Filed: Nov. 21, 2002

(51) Int. Cl. G09G 5/00

(52) U.S. Cl. 345/179

(57) ABSTRACT

The invention includes a method for switching power in a portable computing device and systems and computer media incorporating the method. A method according to the present invention may include providing a removable pointing device configured for attachment to a portable computing device and activating the portable computing device by removing the removable pointing device from the portable computing device. The method may further include concurrently starting a predefined application in the portable computing device in response to removing the removable pointing device. The method may further include closing one or more applications and/or deactivating the portable computing device in response to returning the removable pointing device to the portable computing device. Systems and computer media incorporating the method of the present invention are also disclosed.

### BACKGROUND OF THE INVENTION

1. Field of the Invention

The present invention relates generally to power switching circuits. More particularly, the present invention relates to methods and systems for switching power in a portable computing device in response to removing or replacing a removable pointing device. The present invention also relates to loading of software applications in a portable computing device in response to removing a removable pointing device.

2. Related Art

Portable computing devices such as personal digital assistants (PDAs), laptop personal computers (PCs) and even tablet PCs are becoming ubiquitous. Such portable computing devices give the user freedom to accomplish tasks anywhere they please. Laptop PCs, sometimes referred to as “notebook computers”, generally have a keyboard and some form of pointing device for the user to interact with particular software applications. PDAs and tablet computers are generally too small to incorporate a keyboard. Thus, portable computing devices are typically configured with touch sensitive screens that allow the user to provide input via a removable pointing device.

Examples of portable computing devices include models: Zire™, Tungsten T™, Tungsten W™, m500™, m515™ and i705™ manufactured by Palm, Inc., Milpitas, Calif.; models Treo 90™, Visor Prism™, Visor Edge™, Visor Pro™, Visor Platinum™ and Visor Neo™ manufactured by Handspring, Inc., Mountain View, Calif.; models Compaq iPAQ™ Pocket PC™ and HP Jornada™ Pocket PC™ from Hewlett-Packard Company, Palo Alto, Calif. These portable computing devices typically run the Palm Operating System™ from Palm Inc. or Windows Pocket PC™ from Microsoft Corporation, Redmond, Wash. Tablet PCs are just now coming to market featuring large touch sensitive screens in a tablet or notebook sized format. Tablet PCs are generally designed to run Microsoft's Windows™ XP™ Tablet PC™ operating system. Portable computing device may also include combination PDA and mobile phones, for example, model Thera™ Pocket PC™ from Audiovox Corporation, Hauppauge, N.Y. and model QCP™ 6035 Kyocera Smartphone™, from Kyocera Wireless Corporation, San Diego, Calif.

As noted above, most portable computing devices, including PDAs and tablet PCs include a removable pointing device, often referred to as a stylus. A removable pointing device is shaped much like a pen or pencil. A removable pointing device is typically designed for attachment to the housing of a portable computing device. Some removable pointing devices may even be capable of writing on paper in addition to a touch sensitive screen.

Since portable computing devices rely on battery power for maximum portability, conservation of battery power is usually a design feature. On-off switches on the housing of a portable computing device allow the user to power down the device when not in use. Power management algorithms incorporated into software or hardware may be used to reduce power consumption of portable computing devices at other times such as when the device has been idle for a period of time. Power management may be used to place the portable computing device in a state or mode of low power consumption, i.e., “sleep-mode”, after a defined period of inactivity.

The period of inactivity is sometimes referred to in the art as a “timeout” period. For portable computers such as laptop computers, a timeout may cause the laptop computer to switch into a sleep-mode. Power may be minimized in a sleep-mode by removing power to selected components such as a display and/or one or more hard disk drives. Such a timeout or sleep-mode may occur after a predefined period of inactivity, i.e., when the user does not actuate any input device, e.g., a keyboard or touch sensitive screen, for a predefined period of time.

Before a portable computing device in sleep-mode may be used, it must be powered up again. A portable computing device in sleep-mode may be switched back into a full-power mode by providing input to an input device, by pressing an on-off switch (or some predefined combination of keys on a keyboard or icons on a touch-sensitive screen) on the portable computing device. Conventionally, when a user has finished using a portable computing device and wants to turn off the device, the user can remove power by pressing a power switch or waiting for a timeout to occur.

### SUMMARY OF THE INVENTION

In accordance with one embodiment of the present invention, a method of activating a portable computing device is disclosed. The method may include providing a removable pointing device attached to a portable computing device and activating the portable computing device by removing the removable pointing device from the portable computing device. The method may further include concurrently executing a predefined application in the portable computing device in response to removing the removable pointing device. The method may further include closing one or more applications executing on the portable computing device and/or deactivating the portable computing device in response to replacing the removable pointing device on the portable computing device. Systems and computer media incorporating the method of the present invention are also disclosed.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

The following drawings illustrate exemplary embodiments for carrying out the present invention. Like reference numerals refer to like parts in different views or embodiments of the drawings.

FIG. 1 is a block diagram of a portable computing device according to the present invention.

FIG. 2 is a block diagram of another portable computing device according to the present invention.

FIG. 3 is a flow chart of a method of activating a portable computing device according to the present invention.

FIG. 4 is a block diagram of a computer media for storing a computer program configured for implementing a method according to the present invention.

### DETAILED DESCRIPTION

The invention includes a method of activating a portable computing device and systems and computer media incorporating the method of the invention. Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention. The term “portable computing device” as referred to herein is inclusive of “handheld computing device,” “PDA,” “notebook computer,” “laptop computer,” “tablet PC” and “tablet computer”, “combination mobile telephone with PDA” and foreseeable equivalents that include a removable pointing device. The term “starting an application” is synonymous with “loading and executing an application” as used herein. Similarly, the term “closing an application” is synonymous with “unloading an application” as used herein.

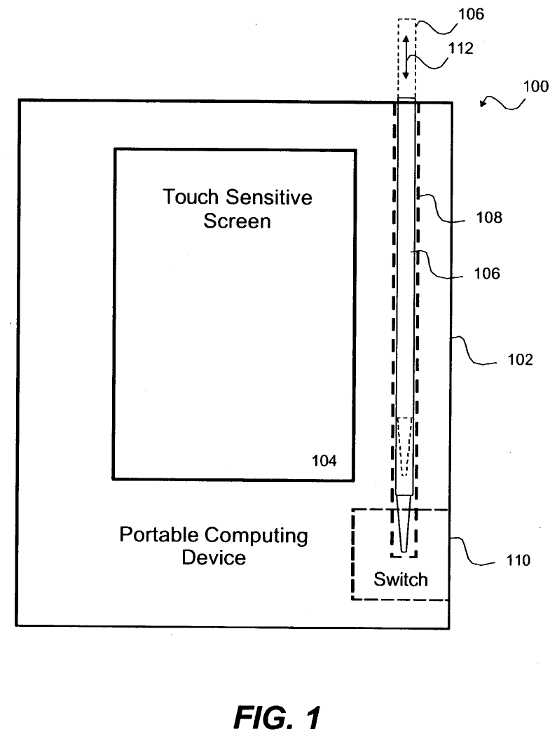

FIG. 1 is a block diagram of a portable computing device 100 in accordance with the present invention. Portable computing device 100 may include housing 102 surrounding and supporting a touch sensitive screen 104. Portable computing device 100 may further include a removable pointing device 106 and a receptacle 108 (shown in dotted line) for attaching the removable pointing device 106 to the housing of the portable computing device 100. Portable computing device 100 may further include a switch 110 for sensing removal (see arrow 112) of the removable pointing device 106. Switch 110 may be configured to activate the portable computing device 100 from an off state or a sleep-mode upon removal of the removable pointing device 106. Switch 110 may be further configured to load and execute an application program (not shown) stored in the memory (not shown for clarity) of the portable computing device 100 from an off state, from a sleep-mode or even from an on state where another application is running. For example, if a user wanted to check a calendar and then take some notes from his portable computing device 100 in the off state, he may power the unit by either pressing the on-off power switch to bring the portable computing device 100 to an on state and then remove the removable pointing device 106 and, thus, concurrent with the removal of the removable pointing device 106 a note taking application may be loaded and ready for use with the removable pointing device 106.

The portable computing device 100 may be configured for various responses to replacement of the removable pointing device 106 depending on the initial state of the portable computing device 100. For example, where the portable computing device 100 is in an on state with any application running, replacement of the removable pointing device 106 into a receptacle 108 may be configured to place the portable computing device 100 into an off state or a sleep-mode without first unloading any or all of the applications running. Alternatively, where the portable computing device 100 is in an on state with at least one application running, returning the removable pointing device 106 into a receptacle 108 may be configured to cause the portable computing device 100 close the at least one application and then proceed into an off state or sleep-mode. Yet another alternative is where the portable computing device 100 is in an on state with a predefined application running. From this initial condition, returning the removable pointing device 106 into a receptacle 108 may be configured to cause the portable computing device 100 to close the predefined application only. Other permutations based on an initial state of the portable computing device 100 and desired responses will be evident to one of ordinary skill in the art and are considered to be within the scope of the present invention.

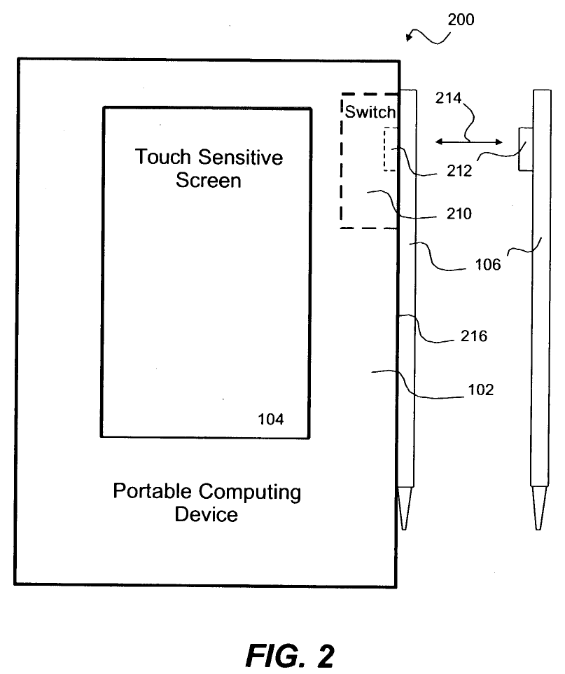

Receptacle 108 may be located within or on the surface (see FIG. 2) of housing 102 of the portable computing device 100. For example, receptacle 108 may be a cylindrical or other shaped opening, hole or slot in housing 102 for sliding the removable pointing device 106 into and out of the opening, hole or slot. In a “receiving port” embodiment of a receptacle 108, the removable pointing device 106 may be mechanically fixed onto the housing 102 by a receptacle 108 formed of a clip, magnet, snap, adhesive, hook and loop material or any other suitable means for securing the removable pointing device 106 to housing 102 as known to one of ordinary skill in the art. The term “receptacle” is inclusive of the terms “opening” and “receiving port” as used herein to describe a means for removably securing a removable pointing device 106 according to the present invention. Additionally, the term “removable pointing device” is inclusive of “stylus” and “writing implement” as used herein.

Switch 110 may be a mechanical switch, a magnetic switch, an electrical switch or an optical switch. Switch 110 may be used to sense the removal of removable pointing device 106 and thereby cause full power (“on state”) to return to a portable computing device 100 that was previously in a sleep-mode or “off state”. In another aspect of the invention, switch 110 may be used to sense the replacement of removable pointing device 106 back into or on receptacle 108 and thereby causing the portable computing device 100 to power down into a sleep-mode or off state. Suitable magnetically activated switches for the present invention may include a magnet in the removable pointing device 106 and a Hall effect sensor in the switch 110, or a Reed switch included in switch 110. Both the Hall effect sensor and the Reed switch may then close or open the power circuit (not shown) of the portable computing device 100, in response to sensing proximity or displacement of the magnet as appropriate.

Removal and replacement of the removable pointing device 106 may be accomplished with a “pulling up” or “pushing down” motion, respectively, as indicated by arrow 112 and shown by the removable pointing device 106 as shown in dotted line. Alternatively, a “push-pop” motion as indicated by arrow 112 may be used to release the removable pointing device 106, whereupon it may be pulled from receptacle 108.

A “push-pop” motion to remove and replace a removable pointing device, like that incorporated in the Compaq iPAQ™ Pocket PC, may be used in conjunction with the switch 110 of the present invention. If the “push-pop” motion 112 is used to activate the portable computing device 100, then the pointing device 106 need not be completely removed from the receptacle 108 in order to effectuate the activation of the portable computing device 100. Instead, the pointing device 106 may reside at a second position (see dashed line for 106) within the receptacle 108. In that second position, the switch 110 has been activated by a partial movement of the pointing device 106 within the receptacle 108 and, thereby, activating the portable computing device 100 (e.g., turning it on or waking it from a sleep-mode). However, if the pointing device 106 is subsequently completely removed, then the portable computing device 100 remains activated. Conversely, if while positioned in the second position, the removable pointing device 106 is pushed inward such that it triggers the switch 110, then the portable computing device 100 is deactivated (e.g., turned off or returned to a sleep-mode). The deactivation may also occur by completely removing the pointing device 106 from the receptacle 108 and then re-inserting the removable pointing device 106 into the receptacle 108 to trigger the switch 110 thereby deactivating the portable computing device 100.

An optical switch may include an optical transmitter of any suitable wavelength and a sensor for sensing the presence or absence of the removable pointing device 106. Of course, other kinds of optical switches suitable for application with the present invention will be readily apparent to one of ordinary skill in the art. Similarly, electrical and mechanical switches capable of sensing the presence or absence of the removable pointing device 106 will be readily apparent to one of ordinary skill in the art and, thus, will not be further elaborated upon herein.

FIG. 2 is a block diagram of another portable computing device 200 according to the present invention. Portable computing device 200 may include a housing 102, touch sensitive screen 104 and removable pointing device 106. Removable pointing device 106 may include a clip 212 for mechanically securing the removable pointing device 106 to the housing 102 and/or switch 210. Thus, in the configuration of portable computing device 200, removable pointing device rests against the surface 216 of housing 102. While FIGS. 1 and 2 illustrate portable computing devices 100, 200 in a PDA configuration, the method of the present invention is applicable to any configuration of portable computing device including a laptop computer with a removable pointing device.

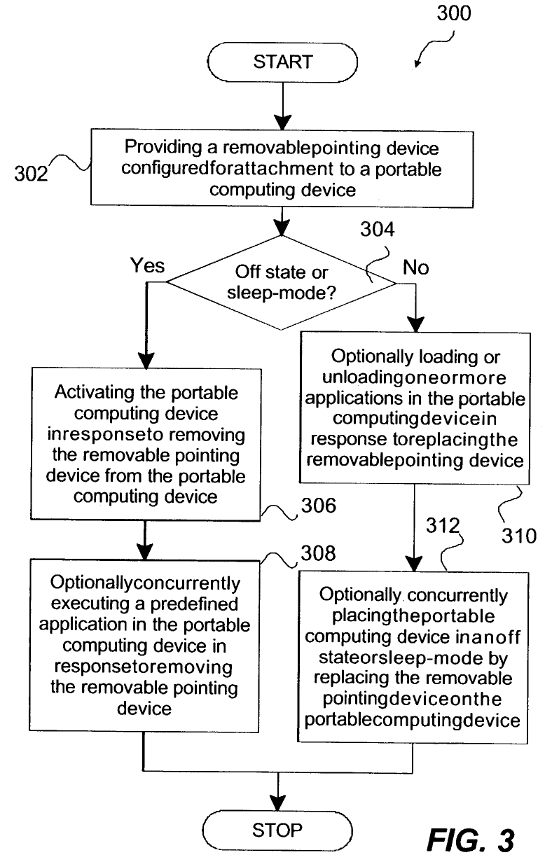

FIG. 3 is a flow chart of a method 300 of switching power and loading applications in a portable computing device in accordance with the present invention. According to method 300 of the present invention, removal of the removable pointing device 106 may have one of the following three effects on the portable computing device 100, 200 depending on its initial state. For a portable computing device 100, 200 in the off state or sleep-mode, a first possible response is placing the portable computing device 100, 200 in an on state. The second possible response may be placing the portable computing device 100, 200 in an on state and loading and executing one or more predefined software applications. For a portable computing device 100, 200 already in an on state, a third response may be selectively loading and executing one or more predefined software applications in response to removing the removable pointing device 106.

Referring again to FIG. 3, method 300 may include providing 302 a removable pointing device 106 configured for attachment to a portable computing device 100, 200. According to the method 300, portable computing device 100, 200 may run any conventional operating system and be configured for executing software applications under the particular operating system. Decision block 304 allows the method 300 to branch depending on the state of the portable computing device 100, 200. If the portable computing device 100, 200 is in an off state or sleep-mode, method 300 may further include activating 306 the portable computing device 100, 200 in response to removing the removable pointing device 106 from the portable computing device100, 200 and optionally concurrently loading and executing 308 a predefined application in the portable computing device 100, 200 in response to removing the removable pointing device 106.

If the portable computing device 100, 200 is in an on state, method 300 may further include optionally and selectively loading or unloading 310 one or more applications on the portable computing device 100, 200 in response to replacing the removable pointing device 106 and optionally concurrently deactivating 312 the portable computing device 100, 200 in response to replacing the removable pointing device 106 on the portable computing device. Deactivating 312 may include placing the portable computing device 100, 200 in an off state or sleep-mode. Replacing the removable pointing device 106 may include sliding the removable pointing device 106 into an opening in the housing 102, or attaching it to a receiving port on the housing 102 of the portable computing device 100, 200. The present invention is insensitive to the particular operating system of the portable computing device 100, 200. Thus, according to the method 300 of the present invention, by removing the removable pointing device 106, a portable computing device may (1) wake up from a sleep-mode or off state, i.e., go into an on state (2) wake up from a sleep-mode or off state, load and execute a preselected application, or (3) if already in an on state, load and execute a predefined software application.

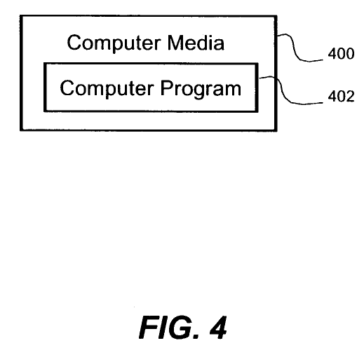

All or portions of method 300 may be incorporated in a computer program 402 (see FIG. 4 and discussion below) for execution by a general purpose or dedicated processor device (not shown for clarity). The computer program 402 may take the form of an executable program, device driver or other form of software or firmware. Alternatively, all or portions of method 300 may be incorporated in digital electronics, for example and not by way of limitation, in the form of an integrated circuit (not shown for clarity) on the portable computing device 100, 200.

FIG. 4 is a block diagram of a computer media 400 for storing a computer program 402 configured for implementing the method 400 of switching power in a portable computing device according to the present invention. Computer media 400 may be any suitable storage medium for storing a computer program 402, e.g., compact disc (CD), mini-disc (MD), read only memory (ROM), programmable ROM (PROM), electrically erasable PROM (EEPROM), nonvolatile electrically block-erasable programmable read only memory (Flash), or any other suitable media for storing a computer program 402. Flash memory for storing a computer program 402 may take many forms, for example and not by way of limitation, Memory Stick™ or SD memory card™ that plugs into the housing 102 of the portable computing device 100, 200. Computer media 400 may also be firmware embedded in the operating system of portable computing device 100, 200, or an applet or plug-in down-loadable and configurable computer program, or device driver for execution on the portable computing device 100, 200. The particular type of computer media 400 and the form of the computer program 402 are not critical to the present invention.

It is to be understood that the above-referenced arrangements are illustrative of the applications for the principles of the present invention. Numerous modifications and alternative arrangements may be devised without departing from the spirit and scope of the present invention. While the present invention has been shown in the drawings and described above in connection with the exemplary embodiments of the invention, it will be apparent to those of ordinary skill in the art that numerous modifications may be implemented without departing from the principles and concepts of the invention as set forth in the claims.

What is claimed is:

1. A method of switching power in a portable computing device, comprising:
providing a removable pointing device configured for attachment to a portable computing device; and
activating the portable computing device from a sleep-mode or off state by removing the removable pointing device from the portable computing device.

2. The method according to claim 1, wherein providing a removable pointing device comprises providing a stylus.

3. The method according to claim 1, wherein providing a removable pointing device comprises providing a writing implement.

4. The method according to claim 1, wherein removing the removable pointing device from the portable computing device comprises removing the removable pointing device from a receptacle in a housing of the portable computing device.

5. The method according to claim 4, wherein removing the removable pointing device from a receptacle in a housing of the portable computing device comprises sliding the removable pointing device from an opening in the housing of the portable computing device.

6. The method according to claim 4, wherein removing the removable pointing device from a receptacle in a housing of the portable computing device comprises mechanically detaching the removable pointing device from a receiving port on the housing of the portable computing device.

7. The method according to claim 1, wherein activating the portable computing device comprises activating a Reed switch during removal of the removable pointing device from the portable computing device.

8. The method according to claim 1, wherein activating the portable computing device comprises activating a Hall effect sensor during removal of the removable pointing device from the portable computing device.

9. The method according to claim 1, wherein activating the portable computing device comprises activating a mechanical switch during removal of the removable pointing device.

10. The method according to claim 1, wherein the activating comprises activating a switch in a receptacle port during a push-pop motion of the removable pointing device.

11. The method according to claim 1, wherein activating the portable computing device comprises activating an optical switch during removal of the removable pointing device.

12. The method according to claim 1, further comprising unloading one or more applications if loaded on the portable computing device in an on state in response to replacing the removable pointing device.

13. The method according to claim 12, further comprising deactivating the portable computing device from the on state by replacing the removable pointing device on the portable computing device.

14. The method according to claim 13, wherein deactivating the portable computing device comprises activating a Reed switch during replacement of the removable pointing device on the portable computing device.

15. The method according to claim 13, wherein deactivating the portable computing device comprises activating a Hall effect sensor during replacement of the removable pointing device on the portable computing device.

16. The method according to claim 13, wherein deactivating the portable computing device comprises placing the portable computing device in a sleep-mode.

17. The method according to claim 13, wherein deactivating the portable computing device comprises placing the portable computing device in an off state.

18. The method according to claim 1, further comprising concurrently executing a predefined application in the portable computing device in response to removing the removable pointing device.

19. A portable computing device comprising:
a computer system;
a pointing device;
a housing containing the computer system;
a receptacle in the housing for receiving the pointing device; and
a switch for sensing whether the pointing device has been removed from the receptacle and configured for waking the computer system in response to removing the pointing device.

20. The portable computing device of claim 19, wherein the switch is selected from the group consisting of: mechanical, magnetic, electrical and optical switches.

21. The portable computing device of claim 19, wherein the switch is further configured for loading and executing a predefined application program on the computer system in response to removing the pointing device.

22. The portable computing device of claim 19, wherein the portable computing device comprises a personal digital assistant.

23. The portable computing device of claim 19, wherein the portable computing device comprises a tablet computer.

24. The portable computing device of claim 19, wherein the portable computing device comprises a laptop computer.

25. The portable computing device of claim 19, wherein the portable computing device comprises a combination personal digital assistant and mobile phone.

26. The portable computing device of claim 19, wherein the pointing device comprises a stylus.

27. The portable computing device of claim 19, wherein the pointing device comprises a writing implement.

28. A computer media for storing a computer program, the computer program implementing a method of switching power to a portable computing device, the method comprising:
providing a removable pointing device configured for attachment to a portable computing device; and
activating the portable computing device from a sleep-mode or off state by removing the removable pointing device from the portable computing device.

29. The computer media according to claim 28, wherein the method further comprises deactivating the portable computing device from an on state by replacing the removable pointing device on the portable computing device.

30. The computer media of claim 28, wherein the method further comprises concurrently executing a predefined application in the portable computing device in response to removing the removable pointing device from the portable computing device.

31. The computer media of claim 28, wherein the computer program is a device driver.

32. The computer media of claim 28, wherein the computer media comprises Flash memory.
